(19) United States
(12) Patent Application Publication
(10) Pub. No.: US 2017/0102131 A1
(43) Pub. Date: Apr. 13, 2017

(54) RECHARGEABLE AND WATERPROOFING UNIVERSAL SERIAL BUS LUMINOUS RING THAT IS CUTTABLE AND EXTENDABLE

(71) Applicant: Shih-Ping CHEN, Taipei City (TW)

(72) Inventor: Shih-Ping CHEN, Taipei City (TW)

(21) Appl. No.: 14/878,867

(22) Filed: Oct. 8, 2015

(51) Int. Cl. F21V 15/01; F21V 23/06; F21V 31/00; F21L 4/08; F21V 23/04; F21V 23/00

(52) U.S. Cl. CPC F21V 15/01; F21V 23/0407; F21V 23/003; F21V 31/00; F21L 4/08; F21V 23/06; F21Y 2101/02; F21Y 2103/003

(57) ABSTRACT

A rechargeable and waterproofing USB luminous ring that is cuttable and extendable includes a tube, an LED seat, a hard shell having a USB receptacle, and plural LEDs. Inside the tube is a string of LEDs connecting to an electric wire. The LED seat, protected by the hard shell, is sheathed by two ends of the tube and is a circuit board. The circuit connecting to the circuit board outside the LEDs is a parallel circuit, two ends of the hard shell include respectively two waterproofing ribs, an end of the hard shell is a switching button and a USB socket, and the other end of the hard shell contains two shields.

### BACKGROUND OF THE INVENTION

a) Field of the Invention

The present invention relates to a USB (Universal Serial Bus) luminous ring, and more particularly to a rechargeable and waterproofing USB luminous ring that is cuttable and extendable. The luminous ring can be cut to the required length of a tube, without damaging the remaining luminous structure. Two ends of a hard shell is equipped with multiple water-proofing functions, so that water will not permeate into an LED (Light Emitting Diode) seat, a USB receptacle and a USB socket without damaging internal electronic parts. Shields are provided to protect an electric wire from being broken due to that the electric wire is bent excessively while using the luminous ring. The luminous ring can be extended by several multiples of the original length, which even expands the range of application for use in all kinds of people, sites and objects.

b) Description of the Prior Art

The decoration in light is required while holding an activity in daylight or night to create the mood. In particular, as young people like to pursue a popular, cool, fancy and special style, they are curious and in love of luminous decorations. Most of the luminous decorations illuminate by LED lights and are provided with many different configurations which are very dazzling. One can see that in a large evening festival site, a show place, a birthday party or a wedding, people will hold luminous strips or luminous rings to increase the mood of activity. They can also wave the luminous strips or luminous rings, along with yelling, clapping and dancing, to raise the morale to the person whom they support. Therefore, the luminous decorations are very indispensable.

Moreover, a car accident can happen quite often when people are jogging along a road side at night or doing an outdoor exercise in the morning, as the light is dusky that the driver is unable to identify the exerciser clearly. Therefore, for their own safety, the exercisers will wear reflective clothing or carry a flashlight so that they can be identified more clearly. A pet can be also hit by a car and get injured or be dead. As the pet cannot hold the flashlight, the pet's owner can only put the reflective clothing or tie a reflective object on the pet. However, the size of the pet is different, and therefore, it is hard to find the reflective clothing that applies to all size. It is also true for the luminous strip or the luminous ring, which is in a single length.

In addition, the conventional luminous ring is provided with the following shortcomings:

1. The luminous ring is in a single length and can be used specially for one specification; it cannot be used universally for people of various sizes, pets of different sizes and all kinds of objects.

2. When the luminous ring is used outdoors, water can permeate into the seams easily to damage the circuit board. In particular, water can enter into the USB charging receptacle very easily.

3. As the seams of the luminous ring are connected by tubes in various outer diameters, a gap (in a shape of a staircase) will be formed. If the gap touches skin of a person, the skin can be scratched, allowing that person to feel uncomfortable.

4. In addition to that the luminous ring is in a single length, the luminous ring cannot be extended, not mentioning being extended by 2 or 3 multiples of the original length.

### SUMMARY OF THE INVENTION

The conventional luminous ring is in a fixed length, unable to be cut, unable to be extended, and unable to be applied to all kinds of people, pets or objects. Moreover, the luminous ring is very poor in waterproofing.

Accordingly, the present invention discloses a rechargeable and waterproofing USB luminous ring that is cuttable and extendable, including a tube, an LED seat, a hard shell which is provided with a USB receptacle, and plural LEDs. An interior of the tube is provided with a string of LEDs connecting to an electric wire. The LED seat is protected by the hard shell which is sheathed by two ends of the tube. The LED seat is a circuit board which is connected with plural rechargeable batteries and a switching circuit. The luminous ring is characterized in that the circuit which is connected to the circuit board outside the LEDs is a parallel circuit, a surface at two ends of the hard shell is provided respectively with two waterproofing ribs, an end of the hard shell is provided with a switching button and a USB socket, and the other end of the hard shell is provided with two shields.

The primary object of the present invention is to provide a rechargeable and waterproofing USB luminous ring that is cuttable and extendable, wherein the luminous ring can be cut to the required length of the tube without damaging the remaining luminous structure, and thus can be applied to all kinds of people, sites and objects.

Another object of the present invention is to provide a rechargeable and waterproofing USB luminous ring that is cuttable and extendable, wherein two ends of the hard shell are equipped with multiple waterproofing functions, so that water will not permeate into the LED seat, the USB receptacle and the USB socket without damaging internal electronic parts, thereby increasing the lifetime of use of the luminous ring.

Still another object of the present invention is to provide a rechargeable and waterproofing USB luminous ring that is cuttable and extendable, wherein the luminous ring can be extended by plural multiples of the original length, which even expands the range of application.

Yet still another object of the present invention is to provide a rechargeable and waterproofing USB luminous ring that is cuttable and extendable, wherein an end of the hard shell is provided with the shields to protect the electric wire from being broken due to that the electric wire is bent excessively while using the luminous ring.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a three-dimensional schematic view of assembling of the present invention.

FIG. 2 shows a three-dimensional schematic view of the present invention, with that a tail end of a tube is separated from a hard shell.

FIG. 3 shows a partial planar view of the present invention.

FIG. 4 shows a partial cutaway view of the present invention.

FIG. 5 shows a planar view of an LED seat of the present invention.

FIG. 6 shows a planar view of the present invention that is bent.

FIG. 7 shows a planar view of a luminous ring of the present invention that is assembled after cutting.

FIG. 8 shows a planar view of the luminous ring of the present invention that is formed by the extension in several sections.

FIG. 9 shows a planar view of the hard shell of the present invention.

FIG. 10 shows a planar view of an electric wire of the present invention that is protected by shields when the electric wire is bent.

### DETAILED DESCRIPTION OF THE PREFERRED EMBODIMENTS

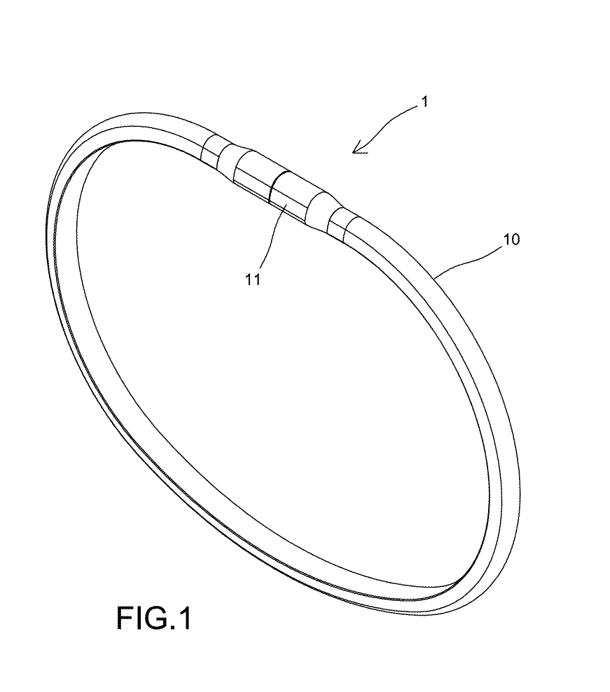

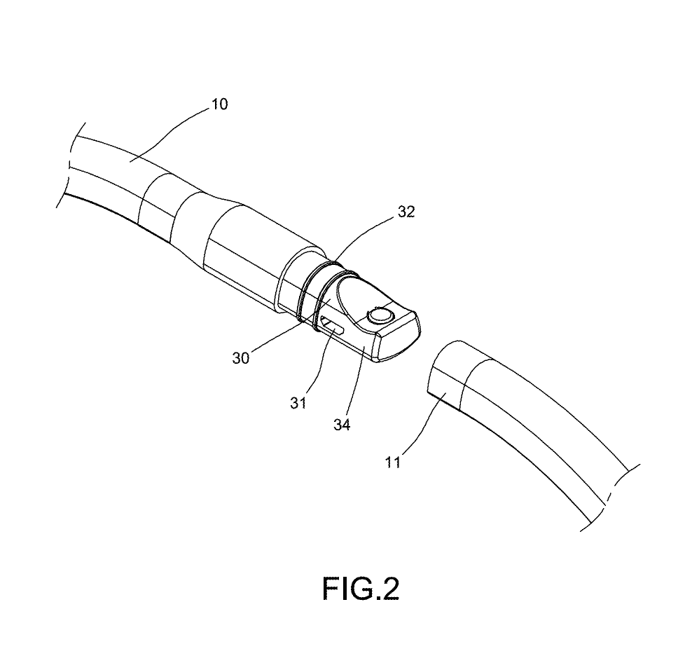

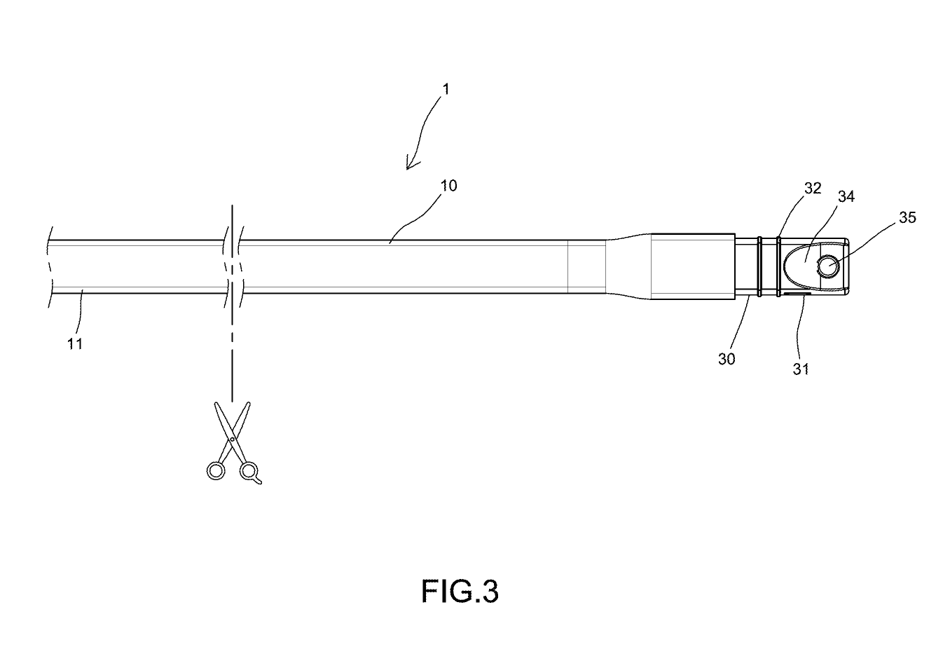

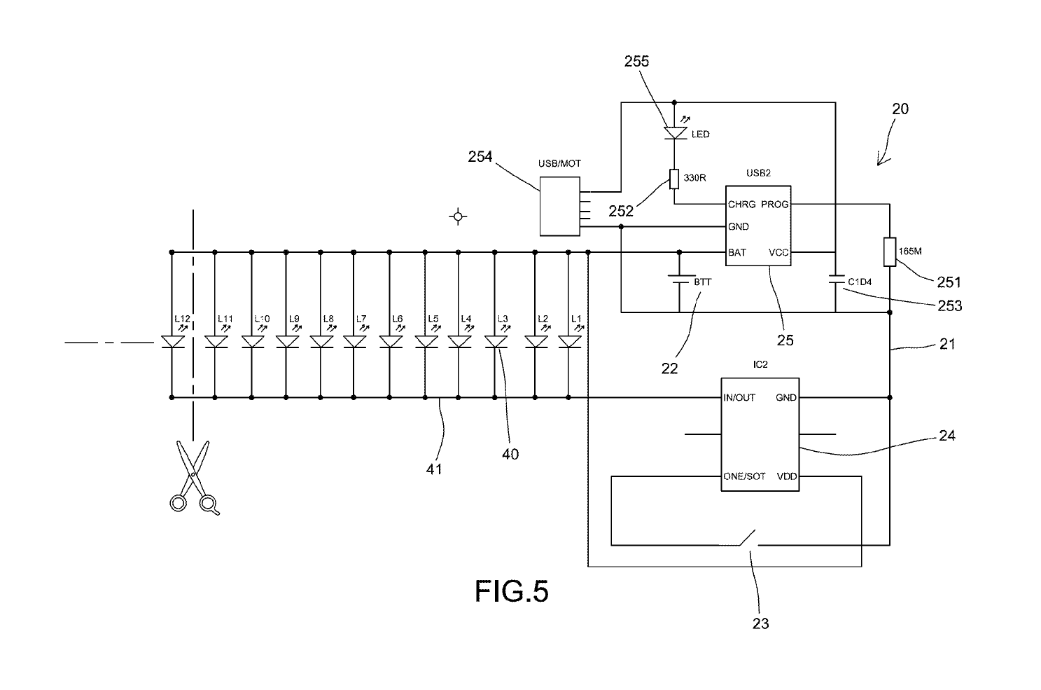

The present invention discloses a rechargeable and waterproofing USB luminous ring that is cuttable and extendable. Referring to FIGS. 1 to 5, a luminous ring 1 comprises a tube 10, an LED seat 20 (as shown in FIG. 5), a hard shell 30, plural LEDs 40 and an electric wire 41 thereof. The tube 10 is a transparent or semi-transparent elastic hose, an end of the tube 10 is sheathed with the hard shell 30, a tail end of the tube 10 is also sheathed with the other side of the hard shell 30, and an interior of the hard shell 30 is provided with the LED seat 20 which is connected to a string of LEDs 40. The LED seat 20 and the string of LEDs 40 are all disposed in the tube 10. The LED seat 20 is protected by the hard shell 30, and two ends of the tube 10 sheath the hard shell 30 to form the annular luminous ring 1. The hard shell 30 is provided with a USB receptacle 31, and the LED seat 20 is a circuit board 21 which is connected with plural rechargeable batteries 22, a switching circuit 23 and the plural LEDs 40. The circuit board 21 is provided with a control IC (Integrated Circuit) 24 which controls the flashing of the LEDs 40. The control IC 24 is connected to the switching circuit 23. The circuit board 21 is also provided with a charging IC 25 which is connected externally with two resistors 251, 252, a capacitor 253, the plural rechargeable batteries 22, a USB socket 254 and a charging light 255. The USB socket 254 is opposite to the USB receptacle 31 of the hard shell 30.

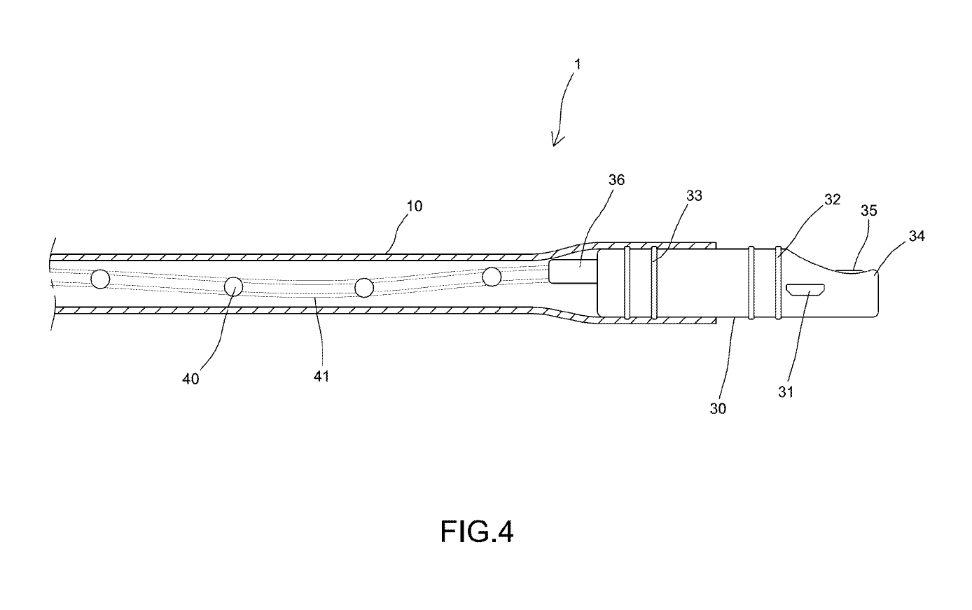

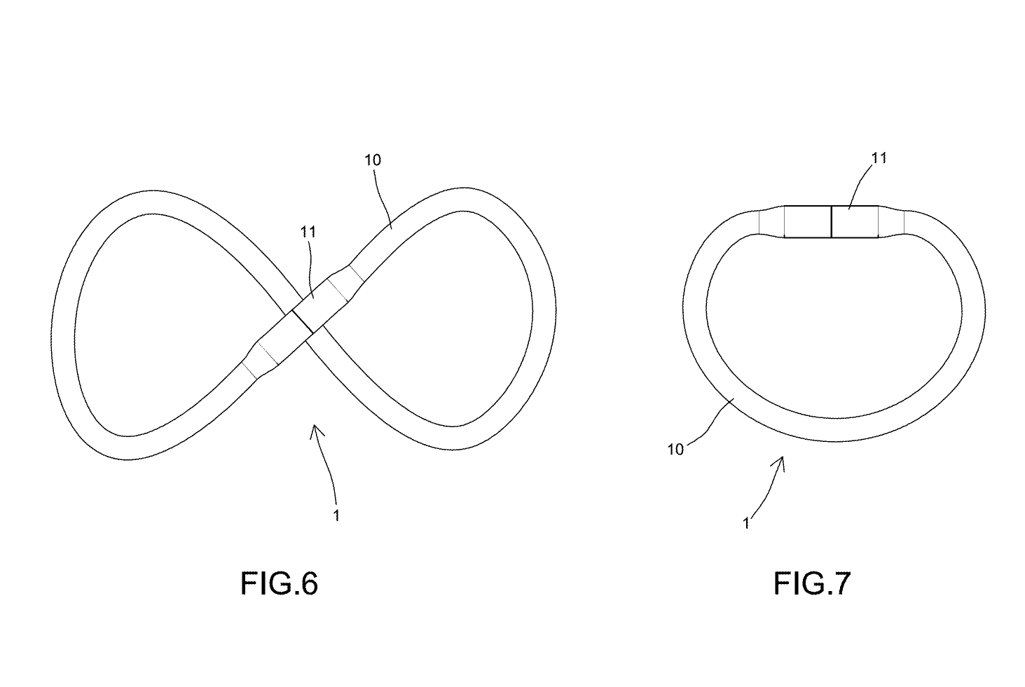

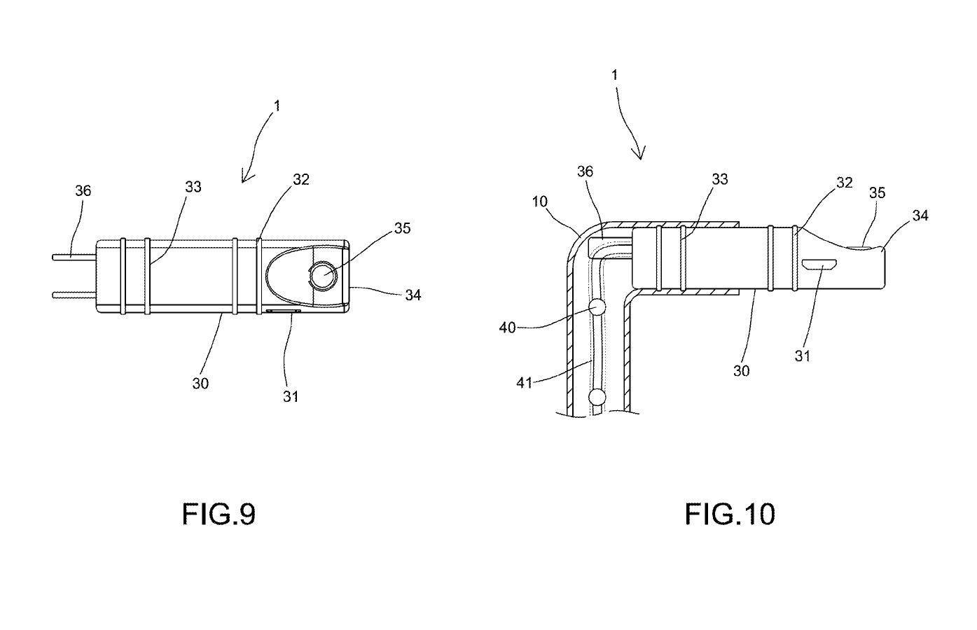

The LEDs 40 are arranged parallel in the circuit (as shown in FIG. 5), so that the circuit that is connected to the circuit board 21 outside the LEDs 40 is a parallel circuit. Two ends of the hard shell 30 are provided respectively with two waterproofing ribs 32, 33 (as shown in FIG. 4), and an end of the hard shell 30 is a converging end 34 which can change the outer diameter. The converging end 34 is flat and is provided with a switching button 35 and the USB receptacle 31. The switching button 35 is overlapped with the switching circuit 23 of the control IC 24. When the switching button 35 is pressed down, the switching circuit 23 will be turned on or off. The switching button 35 can be restored to the original state after being pressed down. An end of the hard shell 30 has already been sheathed by the tube 10, which is accomplished upon delivery. The converging end 34 of the hard shell 30, on the other hand, allows a user to sheath on a tail end 11 (as shown in FIG. 6) of the tube 10 by his or her own. The other end of the hard shell 30 is provided with two protruded shields 36 (as shown in FIG. 9 and FIG. 10). The electric wire 41 penetrates between the two shields 36 and is protected by the shields 36, such that the electric wire 41 will not be broken by being bent excessively while using the luminous ring 1.

By the abovementioned structure, the tail end 11 of the tube 10 and the electric wire 41 of the LEDs 40 can be cut to the required length of the tube 10, depending upon the size of a person's wrist, arm, head or waist, the size of an object or the size of a pet. The cut tube 10 (as shown in FIG. 7) can now be wrapped around the wrist or arm, and then the tail end 11 of the tube 10 can be sheathed on the flat converging end 34 of the hard shell 30, thereby accomplishing the assembly. In addition, the dual protection with two waterproofing ribs 32, 33 allows water not to permeate into the LED seat 20, the USB receptacle 31 and the USB socket 254 without damaging internal electronic parts, and the LEDs 40 on the remaining electric wire 41 can still keep the complete illumination function. The tail end 11 of the cut tube 10 is sheathed on the converging end 34 of the tubular hard shell 30, and the tail end 11 of the tube 10 can be connected with the converging end of another tubular hard shell 30 in the same specification, so as to extend the luminous ring 1 by plural multiples of the original length.

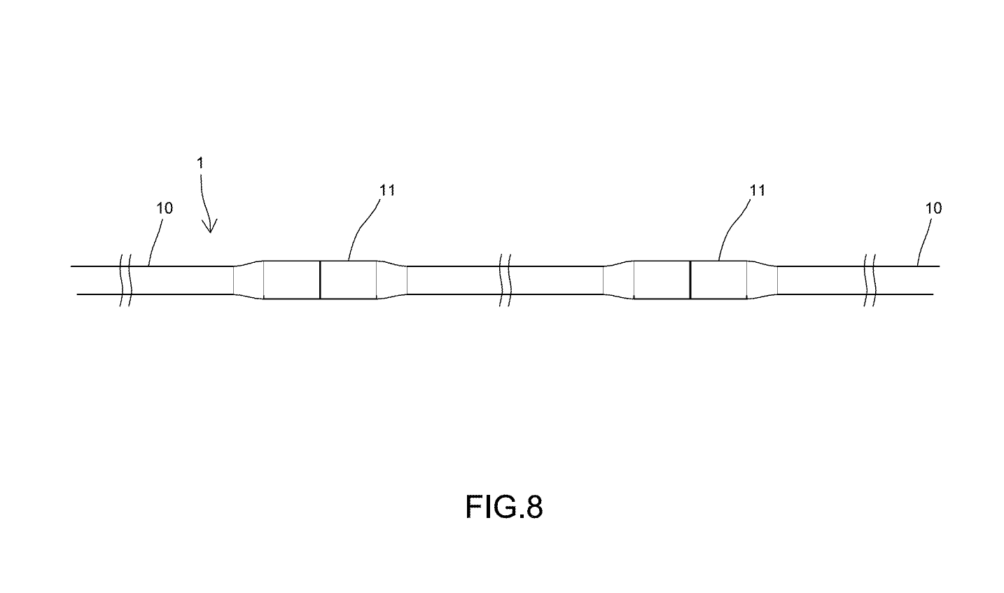

If the luminous ring 1 in a longer length is required, the tail end 11 of the tube 10 can be connected with the flat converging end 34 of the hard shell 10 of a second tube 10 (connecting to the converging end 34 of the hard shell 30 of another tube 10 in the same specification), or can be connected with the flat converging end 34 of the hard shell 30 of a third tube 10 again, so that the luminous ring 1 can be extended by plural multiples of the original length (as shown in FIG. 8) to achieve the required length.

The present invention is provided with the following advantages:

1. The luminous ring 1 can be cut to the required length of the tube 10 without damaging the remaining luminous structure. The luminous ring 1 can be applied to all kinds of persons, sites and objects.

2. Two ends of the hard shell 30 are provided respectively with two waterproofing ribs 32, 33 which increase the stable combination of the tube 10 with the hard shell 30 and serve as multiple waterproofing devices, so that water will not permeate into the LED seat 20, the USB receptacle 31 and the USB socket 254 without damaging internal electronic parts.

3. The electric wire 41 is protected by the shields 36, so that the electric wire 41 will not be broken at the outlet by being bent excessively while using the luminous ring 1.

4. The luminous ring 1 can be extended by plural multiples of the original length, which even expands the range of application.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A rechargeable and waterproofing Universal Serial Bus (USB) luminous ring that is cuttable and extendable, comprising:
a tube, the tube being a transparent or semi-transparent elastic hose, an end of the tube being sheathed with a hard shell, and an interior of the tube being provided with a string of LEDs (Light Emitting Diode); and
a LED seat, the LED seat being protected by the hard shell, the hard shell being sheathed by two ends of the tube, the hard shell being provided with a USB receptacle, the LED seat being a circuit board, and the circuit board being connected with plural rechargeable batteries, a switching circuit, the connected LEDs and an electric wire thereof;
wherein, the circuit connecting to the circuit board outside the LEDs being a parallel circuit, allowing the LEDs to be arranged side by side in the parallel circuit; each end of the hard shell being provided respectively with a waterproofing rib; an end of the hard shell being a converging end which changes the outer diameter, and the converging end being provided with a switching button and a USB socket; another end of the hard shell being protruded with a shield;
accordingly, a tail end of the tube and the electric wire of the LEDs being cut to a required length; water not permeating into the LED seat and the USB socket by the waterproofing ribs; the electric wire being protected by the shields, allowing the electric wire not to be broken due to that the electric wire is bent excessively while using the luminous ring; and the tail end of the tube being connected to the hard shell of another tube, so that the luminous ring is extended by plural multiples of original length.

2. The rechargeable and waterproofing Universal Serial Bus luminous ring that is cuttable and extendable, according to claim 1, wherein the circuit board is provided with a control IC (Integrated Circuit) to control the flashing of the LEDs, with the control IC being connected to a switch.

3. The rechargeable and waterproofing Universal Serial Bus luminous ring that is cuttable and extendable, according to claim 1, wherein the circuit board is provided with a charging IC which is connected externally to two resistors, one capacitor, the rechargeable batteries, the USB socket and a charging light.

4. The rechargeable and waterproofing Universal Serial Bus luminous ring that is cuttable and extendable, according to claim 1, wherein two ends of the hard shell are provided respectively with two waterproofing ribs.

5. The rechargeable and waterproofing Universal Serial Bus luminous ring that is cuttable and extendable, according to claim 1, wherein the converging end of the hard shell is flat.

6. The rechargeable and waterproofing Universal Serial Bus luminous ring that is cuttable and extendable, according to claim 1, wherein there are two shields, and the electric wire penetrates between the two shields.
